(19) United States
(12) Patent Application Publication
(10) Pub. No.: US 2019/0313157 A1
(43) Pub. Date: Oct. 10, 2019

(54) System and Method for a Scalable IPTV Recorder and Cloud DVR

(71) Applicant: James Fitzgerald, San Francisco, CA (US)

(72) Inventor: James Fitzgerald, San Francisco, CA (US)

(21) Appl. No.: 16/379,747

(22) Filed: Apr. 9, 2019

Related U.S. Application Data
(60) Provisional application No. 62/654,730, filed on Apr. 9, 2018.

(51) Int. Cl. H04N 21/472; H04N 21/433; H04N 21/436; H04N 21/2747; H04N 21/258; G10L 15/22

(52) U.S. Cl. CPC H04N 21/47217; H04N 21/4334; H04N 21/43615; G10L 2015/223; H04N 21/25816; G10L 15/22; H04N 21/2747

(57) ABSTRACT

A system and method including steps for: requesting at least one stream from a front end server coupled to at least one of, a database storing streams, a programming database, a recordings database, and an IP or IPTV stream database; receiving the at least one stream from the front end server stored in the IP or IPTV stream database; browsing or searching, with a client device, the at least one stream for a program, in which the client device comprises at least one of, a TV, a mobile device, a desktop, a web browser, and a voice-based assistant; selecting a program for recording to at least one of, a DVR node, said recording database, and said programming database; sending a request, to the front end server, to record the selected program; and receiving a message that a recording process has commenced for the selected program.

### CROSS-REFERENCE TO RELATED APPLICATIONS

The present Utility patent application claims priority benefit of the U.S. provisional application for patent Ser. No. 62/654,730 titled “System and method for a scalable IPTV recorder/Cloud DVR”, filed on Apr. 9, 2018 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to television. More particularly, certain embodiments of the invention relates to television recording.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, an aspect of the prior art generally useful to be aware of is that technology behind delivery of television has typically been moving to an internet-based delivery. Standard cable television services are commonly being redesigned to meet this change in television media delivery. One typical television service is a DVR, where a cable subscriber may store programs on a DVR's storage hardware for watching at a future time, sometimes referred to as “time-shifting”. Users with a DVR device usually have several programs they are storing to eventually catch up on and programs they would like to save long term. DVR storage hardware capacity may be increased but this usually requires changing out the hard disk drives in the DVR device which is oftentimes not possible for an average consumer. Even as storage hardware increases in capacity the limit is typically reached, and it is even more common in households where multiple people are sharing one DVR device. Users are therefore commonly forced to select programs to delete to make space for recording even though they would prefer to keep all of the programs.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system for a cloud DVR, in accordance with an embodiment of the invention;

FIGS. 2A and 2B are a flow chart illustrating a cloud DVR's processing, where FIG. 2B follows the process flow from FIG. 2A, in accordance with an embodiment of the invention;

FIG. 3 is a flow chart illustrating how a node system monitor may process a DVR node's processing capacity, in accordance with an embodiment of the invention;

FIG. 4 is a flow chart illustrating how new program data ingested from a program guide may be identified as matching a series recording request and scheduled for recording, in accordance with an embodiment of the invention;

FIGS. 5A and 5B are a flow chart illustrating a recording node algorithm, where 5B follows the flow process from 5A, in accordance with an embodiment of the invention;

FIG. 6 is a flow chart illustrating a process in an event that fetching a manifest or segment results in an error, in accordance with an embodiment of the invention;

FIG. 7 is a flow chart illustrating an algorithm for creating linear streams from On-Demand or archived content, in accordance with an embodiment of the invention;

FIG. 8 illustrates an exemplary software system modules architecture for a cloud DVR, in accordance with an embodiment of the invention;

FIG. 9 is a block diagram depicting an exemplary client/server system which may be used by an exemplary web-enabled/networked embodiment of the present invention;

FIG. 10 illustrates a block diagram depicting a conventional client/server communication system, which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of and “consisting of limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of or “consisting of a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of or, alternatively, by “consisting essentially of”, and thus, for the purposes of claim support and construction for “consisting of format claims, such replacements operate to create yet other alternative embodiments “consisting essentially of only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

At least some embodiments of the invention provide an architecture and methods for a cloud DVR. The cloud recorder may provide recording/time-shifting of live IPTV streams using cloud components in an infinitely scalable way. IPTV in this case is meant as a generic term to include all internet-delivered television streams. A cloud DVR may be different from a traditional DVR in that no physical DVR hardware may be required. No tuners may be required since streams are not “tuned” into in a traditional sense, but rather accessed via HTTP or other internet protocol. Each component may be an abstract software element hosted by a cloud provider such as but not limited to Amazon's AWS or Google Cloud. Each component in a system may live on completely separate physical hardware or on a same hardware. Each component may also live on completely separate hosting services, optimizing for a most cost-efficient or performant host for each component.

This cloud DVR may provide a unique architecture that may allow independent cloud components to work together to form a cloud DVR infrastructure without traditional dedicated DVR hardware. Proprietary algorithms may allow for IPTV streams to be recorded in a fault-tolerant way. The algorithms may further allow a recording to be accessed while a recording is still in progress (this may be useful for cases of pausing or rewinding live TV). Proprietary scaling algorithms may allow for infinite elasticity of the cloud DVR cluster using a cluster monitor. A set of APIs may be used to interact with the cloud DVR infrastructure. The system may further provide a unique scheduler module. The system may also provide an ability to create linear streams from archived recordings and on-demand content.

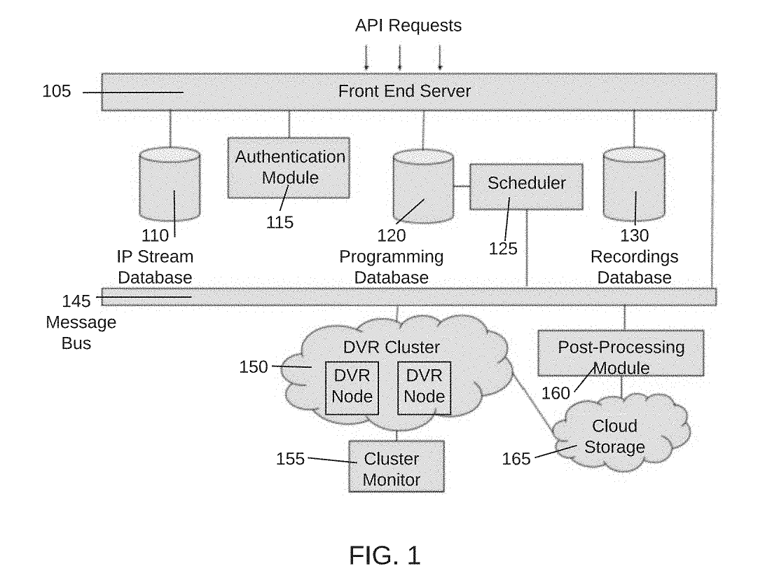

FIG. 1 illustrates an exemplary system for a cloud DVR, in accordance with an embodiment of the invention. Components for this system may include, a database of linear IPTV streams (URLs where each stream may be accessed) 110, an optional authentication module 115, a frontend server providing an API to provide programming information and accept recording requests 105, an optional database or service that provides Program Guide data of what programs air on each live stream at what times 120, a database of user-requested recordings for each program 130, a scheduler 125, a cluster of one or more DVR nodes 150, an optional monitor to ensure that enough capacity exists in a cluster 155, an optional message bus connecting components 145, an internet accessible storage medium or Content Delivery Network (CDN) 165, and an optional post-processing node 160. An application may make an API call to request a list of available streams and their corresponding programs from a front end server 105 which may pull from a database of IPTV streams 110 and may serve it to a user or application. IPTV streams may come via any format, including but not limited to HLS (HTTP Live Stream), MPEG-DASH, SmoothStream, Adobe HDS, RTMP, RTSP/RTP, WebRTC, etc. A user may browse programs that may be on each stream and, if the stream is linear, the user may see what time a desired program may be available on a stream. A “linear” stream is defined as a stream that has no ending and programs are streamed at a certain time like traditional television. An “on-demand” stream is defined as a stream that has a singular program on the stream, and the stream ends when the program is finished. A user may browse these programs through a Program Guide on any computing device such as TV, mobile device, desktop, web browser, voice-based assistant, etc. They may also search for programs on their device through text input or voice input to their TV or voice-based assistant device such as Amazon Alexa or Google Assistant. Example voice inputs are “Record the Simpsons on Fox tonight”, “Record all episodes of the Simpsons”, “Record all new episodes of The Simpsons”, “What's on TV now?”, “What's on primetime tonight?”, “What's on NBC tonight?”, etc. After a given voice response, the user may follow-up with a command such as “Record that”, or if given a list of options, naming a specific option such as “Record the Simpsons”. The list of options may be customized for the user based on their live viewing history and/or recording history. For example, the list may be prioritized based on what's “interesting” to a user, based on their favorite channels, shows, genres, actors, directors, creators, etc. The user may always opt to expand the list further by selecting or instructing to “see/hear more”. The voice assistant interacts with the system via API calls in a request/response manner. The user may select a program for recording and the client may send a request to a front-end server 105. The front-end server 105 may save a user's requested recording information to a recordings database. At the time the program is set to be available on the stream, the scheduler 125 sets up the recording job: If a stream requires authentication and an authentication server 115 may grant the user or application access to a requested stream and may pass authentication information such as an authentication token attached to the URL or in a cookie value. A message may be sent via a message bus (job queue) 145 which a node in a DVR cluster 150 (where multiple DVR nodes may reside) receives and processes. Alternatively, the message may be sent directly to a node that is least utilized. The authorization may also come from a cache and does not necessarily have to be performed in real time, with a TTL (time-to-live) that is appropriate for the desired level of security. A message may contain stream information such as the complete URL of the stream with authentication tokens if necessary, cookie key/values for authentication if necessary, and a duration or end time to determine for how long a node should record a stream. The message may also contain metadata such as a channel id and episode information from which the final playback url and duration/end time can be queried or otherwise determined. Alternatively, besides a finite duration, the duration or end time may be omitted and the message may instruct the recording node to record until otherwise directed. This may be desired in the event of a sporting event or other live event which the duration is not easily determined ahead of time and the allotted duration is often wrong. The node can then wait for an additional message or signal that tells it that the event has ended and recording can be completed. Upon processing a message, a DVR node may send a message that recording has commenced for a specified program and begin saving the stream to a cloud storage medium 165 for a specified length of a user-requested program. This process may consist of transcoding media from an IPTV streaming format to an appropriate playback format, or a simple byte-for-byte copy of a stream to a cloud storage medium. During this process, further processing may be performed such as compression of the stream, transcoding to other compression codecs, decrypting and/or encrypting the stream if desired for security. For example, the source stream may be h.264 but h.265 is more bandwidth efficient for playback so we can transcode from h.264 to h.265 at this step or flag for transcoding during post-processing. Also the original stream may be encrypted in a certain way and the system may decrypt the stream and optionally re-encrypt the stream using another encryption method, depending on the desired playback devices' capabilities and level of security/DRM desired. This may also be done in real-time or during post-processing. Multiple bitrates may by saved at once, allowing for later playback on devices with varying bandwidth capabilities. Otherwise, depending on capabilities of a DVR node, a single bitrate stream may be saved and then transcoded to multiple bitrates and/or other compression formats/codecs later during post-processing. This will be dependent on the capabilities of the recording nodes, such as memory, CPU performance and/or hardware capabilities such as built-in video compression hardware or GPU-assisted encoding and other common performance criteria for video decoding/encoding. An entry for a recording in the database 130 may be marked as in progress. Upon completion of a recording, a DVR node may send a message stating that a recording is complete. If an error occurs during a recording process, software may attempt to recover. See below for a description of an error recovery algorithm. If recovery may not be possible, a recording in a recordings database 130 may be marked as failed, otherwise if the recording is successful, an entry for a recording in the recordings database 130 may be marked as complete. If a recording at a specific time has failed and the episode is available at a later time, then a alternative recording may be scheduled for the later time and/or alternative channel or on-demand stream. The recording may now be served from a cloud storage medium or CDN 165. An optional post-processing node 160 may then react to a recording complete message to perform further processing on a recording. This may include but is not limited to further transcoding to different streaming bitrates and formats, commercial detection/flagging, decryption and/or encryption, DRM, automated transcription for closed captioning if otherwise unavailable, closed captioning indexing, scene detection and indexing, image processing such as object or actor recognition with time markers, encryption or decryption of the stream, etc.

As each DVR node reaches its processing capacity, whether that capacity may be limited due to CPU/GPU, memory, bandwidth, software or hardware errors, network errors, simultaneous network connection limitations, etc, it may stop accepting new recording messages from a bus and provide a status that it is unavailable for new recordings. Alternatively the node monitor may detect that the node is reaching capacity and stop sending recording jobs to it. The monitor may detect that a node is reaching capacity based on a predetermined limit (i.e. it is known that nodes of a specific configuration can handle at most 10 simultaneous recordings), or real-time monitoring of the performance data of each node. This performance data could include the memory remaining, CPU load, network bandwidth up/down load, network error count, etc. A system monitor 155 may then look at an entire cluster of nodes to see what capacity remains across all nodes and decide to spin up new nodes if need be. The current job load of each node can either be exposed to the monitor via API (i.e. the node has a simple server that can be called to determine the number of current recording jobs currently being processed), or a central database can be the master record for which nodes are processing which jobs. This can be possible by having each node notify the system that it has picked up a recording job off of the message bus and has begun recording. Then the system can persist which node is processing which job in the database. Alternatively, the scheduler can persist which jobs were sent to which nodes. Then, a determination of the remaining capacity of the cluster may be done by querying each node or by querying the persistence layer. As recordings finish and more capacity may be freed, a monitor 155 may shut down unused nodes to reduce costs. This system monitor 155 may also anticipate additional needed capacity by analyzing the recordings database 130 and start up additional DVR nodes to meet that anticipated capacity. For example, during primetime at 7 pm, if 3000 recordings are scheduled and each node can handle 30 recordings, then a monitor 155 may know that 100 nodes may be needed at 7 pm so a few minutes before 7 pm it may startup new nodes so that a cluster contains at least 100 nodes by 7 pm. This process may start a few minutes before or as long as it may take for the necessary number of node to start up and become available to accept recordings on behalf of the cluster. A monitor may also detect that a node has become unresponsive (i.e. hasn't reported in a period of time, or has stopped responding to queries) and attempt to restart or replace it. It may detect that recording capacity of the cluster has been limited due to outside factors such as problems with the cloud service provider. In this situation, it may start new nodes in alternative data centers. Some storage providers have rate limits to storage requests or other API calls, so the monitor take these limits into consideration and balance the load to different storage mediums so these limits are not reached.

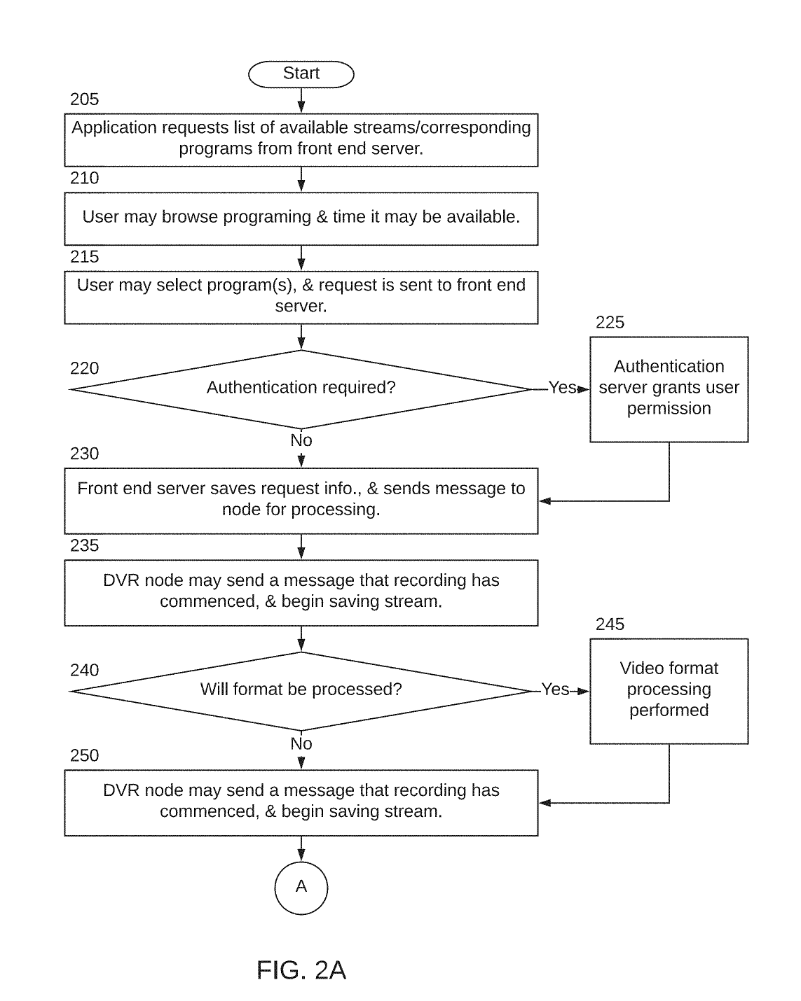

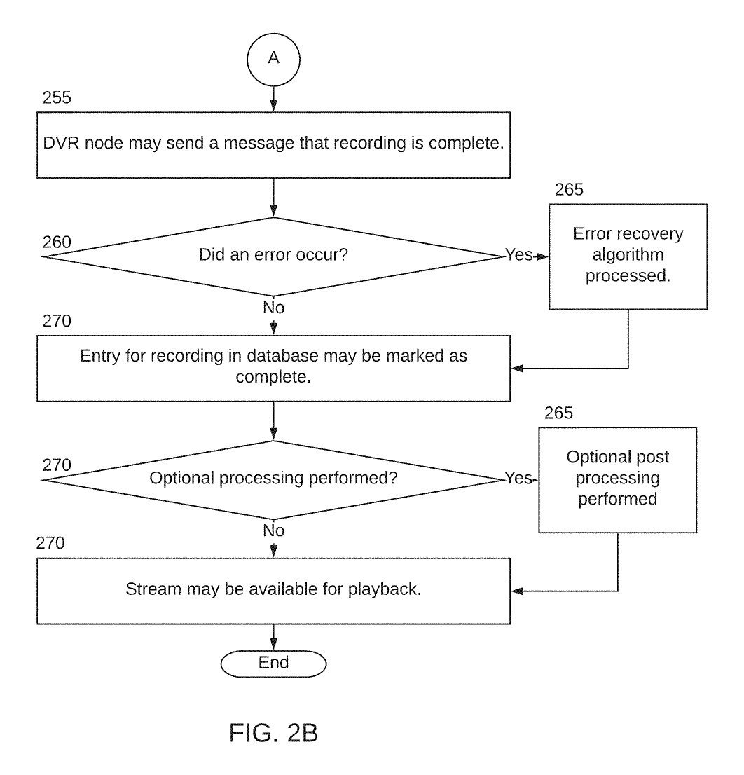

FIGS. 2A and 2B are a flow chart illustrating a cloud DVR's processing, where FIG. 2B follows the process flow from FIG. 2A, in accordance with an embodiment of the invention. In a Step 205 an application may make an API call to request a list of available streams and their corresponding programs from the front-end server which may pull from a database of IPTV streams and may serve it to a user or application. In a Step 210 a user may browse programs that may be on each stream and, if the stream is linear the user may see what time a desired program may be available on the stream. A user may browse these programs through a Program Guide on any computing device such as TV, mobile device, desktop, web browser, voice-based assistant, etc. They may also search for programs on their device through text input or voice input to their TV or voice-based assistant device such as, but not limited to Amazon Alexa or Google Assistant. In a Step 215 the user may select a program for recording which may send a request to a front-end server. In a Step 220 there may be a decision processed regarding if authentication is required. If a stream requires authentication in a Step 225 an authentication server may grant the user or application access to a requested stream. The authorization may also come from a cache and does not necessarily have to be performed in real time, with a TTL (time-to-live) that is appropriate for the desired level of security. If no authentication is required or after authentication has been processed, in a Step 230 the front-end server may save a user's requested recording information to a recordings database an IPTV stream, and it may send a message via a message bus which a node in a DVR cluster (where multiple DVR nodes may reside) receives and processes. In a Step 235 upon processing a message, a DVR node may send a message that recording has commenced for a specified program and begin saving an IPTV stream to a cloud storage medium for a specified length of a user-requested program. In a Step 240 there may be a decision processed regarding if format processing may be performed. This decision will be based on the capabilities of the node. In most embodiments, it is desired to do CPU intensive format processing in the post-processing step as real-time processing should be reserved for the most critical tasks, i.e. making sure the recording is saved from the live stream properly. If format processing is to be performed, in a Step 245 processing may consist of transcoding media from an IPTV streaming format to an appropriate playback format, or a simple byte-for-byte copy of a stream to a cloud storage medium. During this process, further processing may be performed such as compression of the stream, transcoding to other compression codecs, decrypting and/or encrypting the stream if desired for security. For example, the source stream may be h.264 but h.265 is more bandwidth efficient for playback so we can transcode from h.264 to h.265 at this step or flag for transcoding during post-processing. Also the original stream may be encrypted in a certain way and the system may decrypt the stream and optionally re-encrypt the stream using another encryption method, depending on the desired playback devices' capabilities and level of security/DRM desired. This may also be done in real-time or during post-processing. Multiple bitrates may by saved at once, allowing for later playback on devices with varying bandwidth capabilities. Otherwise, depending on capabilities of a DVR node, a single bitrate stream may be saved and then transcoded to multiple bitrates later during post-processing. If no format processing is required or after format processing is completed, in a Step 250 an entry for a recording in a database may be marked as in progress and a stream may be saved. The process flow may then proceed through “A”, to FIG. 2B. In FIG. 2B in a Step 255 upon completion of a recording, a DVR node may send a message stating that a recording is complete. In a Step 260 a decision may be made regarding if an error has occurred. An error is determined to have occurred if the host server for the stream returns a commonly known error code in response to a request for a manifest and/or segment. These error codes can be common HTTP error codes such as 4xx or 5xx responses. Other errors can be socket timeout (failure to get a server response in time), SSL handshake errors, or other connectivity issues. Additional errors can be detected by determining if the segments we have seen have been sequential. In the various streaming formats, each segment sometimes have a sequence number and/or filename with an embedded incrementing number in it. We can analyze these segments to determine if we have any missing segments and attempt error recovery as necessary. If an error occurs during a recording process, in a Step 265 software may process an error recovery algorithm. If recovery may not be possible, a recording in a recordings database may be marked as failed. Recovery may not be possible if the host server returns errors or cannot be reached for a prolonged period of time, if the necessary segments for recovery have moved beyond the live window and filename determination for the missing segments is not possible. If an error has not occurred or the error recovery algorithm succeeds, in a Step 270 an entry for a recording in the recordings database may be marked as complete. A recording may now be served from a cloud storage medium or CDN. In a Step 275 a decision may be made regarding if additional optional processing may be performed. If more processing may be performed, in a Step 280 an optional post-processing node may then react to a recording complete message to perform further processing on a recording. This may include but is not limited to further transcoding to different streaming bitrates and formats and commercial detection/flagging. This decision will be based on the configuration of the Cloud DVR system for the desired behavior. In a Step 285 once final post processing is complete a stream may be available for playback.

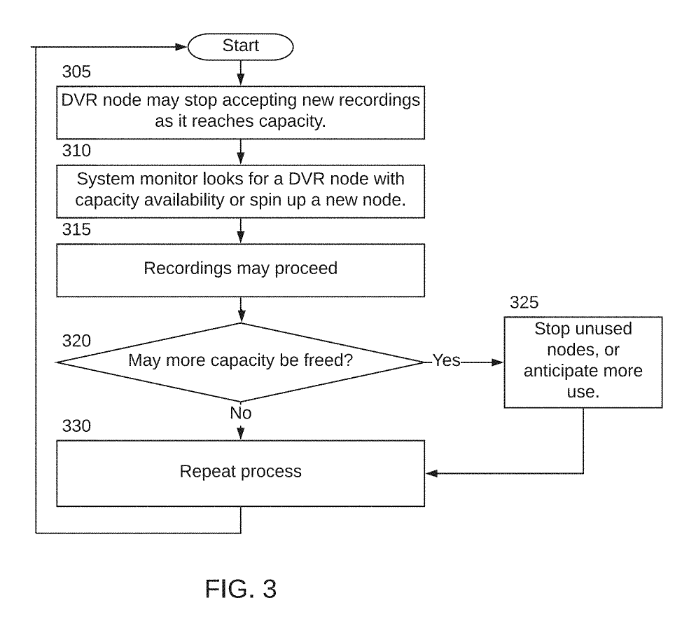

FIG. 3 is a flow chart illustrating how a node system monitor may process a DVR node's processing capacity, in accordance with an embodiment of the invention. In a Step 305 as each DVR node reaches its processing capacity, whether that capacity may be limited due to CPU/GPU, memory, bandwidth, software or hardware errors, network errors, simultaneous network connection limitations, etc, it may stop accepting new recording messages from a bus and provides a status that it is unavailable for new recordings. Alternatively the node monitor may detect that the node is reaching capacity and stop sending recording jobs to it. A node may be determined to be reaching capacity based on a predetermined limit (i.e. it is known that nodes of a specific configuration can handle at most 10 recordings), or real-time monitoring of the performance data of each node. This performance data could be the memory remaining, CPU load, network bandwidth up/down load, etc. The current job load of each node can either be exposed to the monitor via API (i.e. the node has a simple server that can be called to determine the number of current recording jobs currently being processed), or a central database can be the master record for which nodes are processing which jobs. This can be possible by having each node notify the system that it has picked up a recording job off of the message bus and has begun recording. Alternatively, the scheduler can persist which jobs were sent to which nodes. Then, a determination of the remaining capacity of the cluster may be done by querying each node or by querying the persistence layer. In a Step 310 a system monitor may then look at an entire cluster of nodes to see what capacity remains across all nodes and decide to spin up new nodes if need be. In a Step 315 the recording may then proceed. In a Step 320 a decision may be made regarding if more capacity may be freed. If more capacity may be freed, in a Step 325 a monitor may shut down unused nodes to reduce costs. This system monitor may also anticipate additional needed capacity by analyzing the recordings database and start up additional DVR nodes to meet that anticipated capacity. In a Step 330 the system monitor may stay vigilant and repeat the whole process.

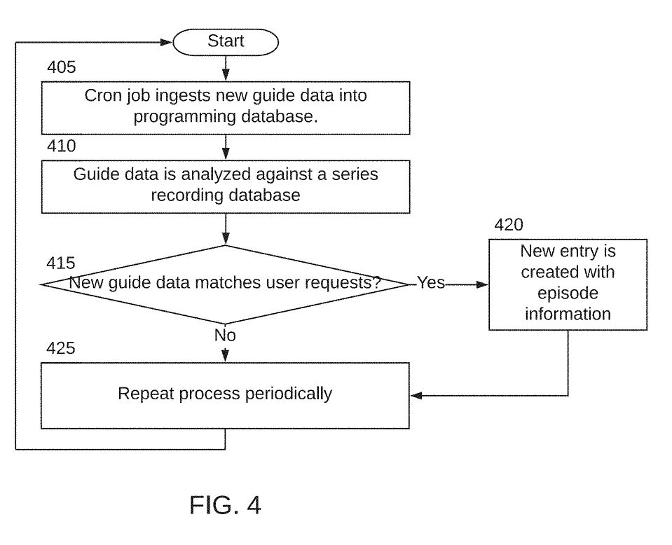

FIG. 4 is a flow chart illustrating how new program data ingested from a program guide may be identified as matching a series recording request and scheduled for recording. A user may wish to record every episode of a television series, and so through the UI the user selects a program and opts to create a series recording. The user may also search for series using a keyboard, voice input or other Human Interface Device. Various options for the series may be presented to the user as well, such as record new episodes only, record only a certain number of episodes, record only episodes from a given season, record only when on certain channels, etc. When they select a series, the client sends an API request to the front-end server to create a series recording entry in the database.

In a step 405 a cron job may periodically (usually every night, but may be hourly or multiple thereof) run in order to ingests new guide data into a programming database. Usually multiple days of programming data is ingested at once, but ideally should be updated at least each day even if a day has already been fetched, as schedules can change. In a Step 410 when this guide data may be ingested it may be analyzed against a series recording database. In a Step 415 a decision may be made regarding for each episode in a new guide data, if that matches a user-requested series to record and a user did not request that only new episodes in a series be recorded or if an episode is new. If that is true, then in a Step 420 a new entry may be created in a recordings database with an episode's information (date/time/channel) and status of the recording indicating that it is an upcoming recording. Additional metadata about the episode may also be stored, such as series title, episode title, original airtime, season number, episode number, imagery, unique identifiers, whether the episode is new or a repeat, and/or category information. In a Step 425 this process may then be repeated periodically.

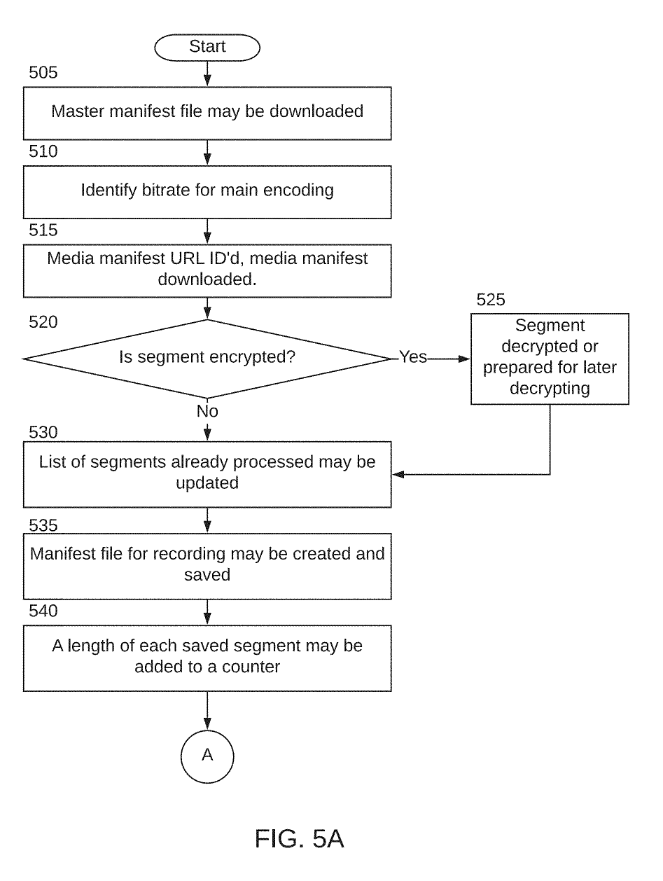

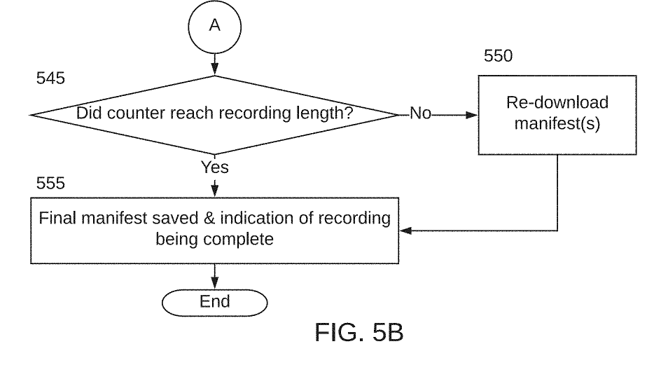

FIGS. 5A and 5B are a flow chart illustrating a recording node algorithm, where 5B follows the flow process from 5A in accordance with an embodiment of the invention. One variation of an algorithm may consist of (example given is for an HLS stream): the main URL of an HTTP live stream may typically be a master manifest file (in a case of HLS or MPEG-DASH). A master manifest file may consist of a list of sub-manifests that may contain segments encoded at different bitrates. The master manifest file may also itself be a media manifest and contain a list of segments. A segment may typically be 1-60 seconds of encoded audio and video. In a Step 505 a master manifest file may be downloaded and saved to memory. In a Step 510 for each sub-manifest in a master manifest, identify bitrates at which a main encoding should take place at (this may typically be a highest available bitrate at which downsampling may safely be performed later but upsampling results in loss of quality). in a Step 515 a URL for a media manifest for those bitrates may be identified and the media manifest may be download to memory. For each audio/video segment in media manifests, contents may be fetched and saved directly to an internet accessible storage service (such as a cloud storage provider or CDN). For closed systems, such as those operated by an MSO/MVPD, the storage servers may be accessible only on their own private network and delivered to their users over that private network. In a Step 520 a decision may be made if a segment is encrypted. If it is encrypted then in a Step 525 decrypting may be performed at this time or encryption information may be saved (typically from a manifest) so that it may be decrypted later. In a Step 530 a list of segments that have already been processed may be maintained (using a sequence ID of segments) so that for subsequent refreshes of a manifest, a system may skip already processed segments. We may also maintain a list of processed filenames, which may be useful if the sequence ID unexpectedly “resets” to 0 or goes backwards. If this occurs, we may use the filename list to determine which segments have already been processed so as not append the same segment twice to the recording. In a Step 535 a manifest file for recording with segment information (URL, etc.) may be created, and saved to a storage medium. While a recording may still be in progress, this recording manifest may not be marked as final (for HLS this is the #EXT-X-ENDLIST tag at an end of a manifest), This may signal to clients that a manifest should be refreshed periodically to get new segments as a recording progresses, Clients may also look at the status of the recording to determine whether the recording is in progress and should be periodically refreshed. While a recording may be in progress, it may be important that a cloud storage medium does not cache a manifest and that HTTP responses to fetch a manifest include a “Cache-Control: no-cache” header. This ensures that as soon as new segments are available, a new manifest reaches clients and a cache does not return a stale manifest. Clients may begin accessing a recording as soon as a first manifest is saved.

In a Step 540, a total length of each saved segment may be added to a counter. In a Step 545 a decision is made regarding if a counter has reached a desired recording length. If it has reached a desired recording length, in a Step 555 a final manifest may be saved for a recording (in HLS this is marked with a #EXT-X-ENDLIST tag, but is different for each streaming format), a process may be exited and a message may be sent on a message bus indicating that a recording is complete. A listener may receive this message and mark a recording as complete in a recordings database. If a counter has not reached a desired recording length, in a. Step 550 media manifest(s) may be re-downloaded. In a live stream scenario, manifest(s) may have been updated with new segments. The segments that have already been processed may be skipped over (using a list of already processed segments mentioned above), new segments may be saved to a cloud storage medium and a recording manifest may be updated with new segments.

To be more efficient and to avoid hammering a live stream server, a system may want each loop through a manifest to result in an optimal number of segments fetched. Therefore, a system may typically want to sleep for a period of time before re-fetching a manifest to maintain a minimum re-fetch time. This minimum re-fetch time may typically be a fraction of a manifest length (otherwise known as a live-window). For example, if a manifest contains 60 seconds of segments (6 10 second segments), and a system saves all 6 segments in 10 seconds and a system has a fraction of 0.5, a system's minimum re-fetch time will be 30 seconds (0.5 of the 60 second live window). Therefore, a system may want to sleep for 20 seconds before re-fetching a manifest. A system may want this fraction to be high enough that a system doesn't overly hammer a server, and low enough that in an event of an error or network congestion, a maximum number of retries may occur before missing segments “fall off” a live-window. Also a system may want this fraction to be low enough such that clients accessing a recording while it is still in progress may get new segments in a timely manner. Usually we want the manifest to be updated every 30 seconds or less, as clients tend to start playback 30 seconds from the live edge. A higher update period will result in more pausing/buffering of the recording playback while it waits for new segments to appear in the manifest.

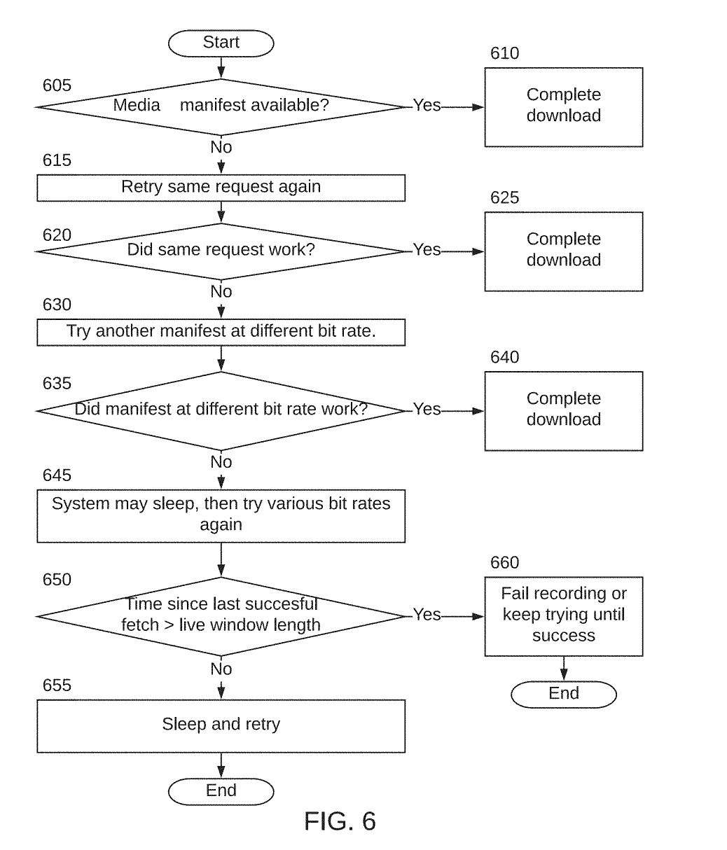

FIG. 6 is a flow chart illustrating an error recovery process, in accordance with an embodiment of the invention. For IPTV streams, the servers serving the stream are sometimes unreliable and can return errors for manifest or segment requests. These errors can include common HTTP error codes such as 4xx or 5xx responses. Other errors can be socket timeout (failure to get a server response in time), SSL handshake errors, or other connectivity issues. Additional errors can be detected by determining if the segments we have seen have been sequential. In the various streaming formats, each segment sometimes have a sequence number and/or filename with an embedded incrementing number in it. We can analyze these segments to determine if we have any missing segments and attempt error recovery as necessary. Without error recovery logic, a large percentage of recordings may fail. Each stream may have what's called a “live window” for buffering purposes. Typically this live window may be 30 seconds to several hours into the past (the larger a window, the more fault-tolerant it is). If a stream server goes down for 10-20 seconds, typically when a server comes online again, lost minutes are still available as part of a live window. An error recovery algorithm may attempt to identify missing segments of a stream and reach into a live window to retrieve those missing segments. In a Step 605 a decision may be made regarding if an entire media manifest may be unavailable. If an entire media manifest is available, then in a Step 610 a system may complete a download. If an entire manifest is not unavailable, then in a Step 615 a system may try a same request again a few times. In a Step 620 a decision may be made regarding if the same request worked. If the same request did work, then in a Step 625 a download may complete. If all attempts still result in an error, in a Step 630 a system may try the other media manifests (at various bitrates). The program shall look to the master manifest file to find an alternative stream. The system may traverse this manifest in descending bitrate order. If the next-highest bitrate manifest also returns an error, then the 3rd highest bitrate manifest should be tried, etc. In a Step 635 a decision may be made regarding if trying with various bit rates worked. If trying with various bit rates did work, then in a Step 640 a download may complete. If trying various bit rates did not work, then in a Step 645 a system may sleep for a small period of time (for example, 10 seconds or small fraction of the live window) and then attempt each media manifest again, starting with a preferred bitrate. The preferred bitrate is usually the highest bitrate that meets a threshold. It may be desired to limit the max bitrate allowed to save on bandwidth. In a Step 650 a decision may be made regarding if a time since a last segment was successfully fetched doesn't exceed a live window length (in this example, 60 seconds). If a time since a last segment was successfully fetched doesn't exceed a live window length (in this example, 60 seconds), then in a Step 655 a system may sleep and retry. If a system does exceed this length, then in a Step 660 a system may attempt to recover. If recovery is not possible or a max number of attempts is made then the recording may be marked as failed and the process shall exit. In this case, there may be missing segments. If a segment is missing, we may be able to determine which one is missing by examining the sequence numbers or file names of the segment urls. Usually segment file names include an incrementing number embedded in it. If a segment is determined to be missing, we can attempt to infer the url of the missing segment by incrementing this embedded number of the last known segment url. If this inferred url is valid, we may continue this process until there are no more missing segments. If not all missing segments are able to be recovered, the first segment that's successfully fetched may need to be marked as discontinuous. A system may note how much of a recording is missing and inform a user. For live streams that have repeated errors, a system may lower it's minimum refetch time to allow for more retry attempts in an event of a failure.

Example APIs to the front-end service may include but are not limited to the following. “GetRecordings” may return recordings for a given user. “ScheduleRecording” (schedule a program) may schedule a recording in a recording database. A program object at a minimum may contain an IPTV stream URL or ID, a start time and a duration (or end time). Metadata associated with a program to be recorded may be saved as well, such as information including but not limited to title, series information and description. “GetChannels” may return a list of IPTV streams which may be recorded. “GetUpcomingPrograms” may return a list of upcoming programs for a given IPTV stream that may be recorded. “RecordSeries” with arguments (seriesId, channel, newEpisodesOnly) may record a given series identified by information including but not limited to a series ID, an optional channel (only records a series when it appears on a given channel) and whether or not to only record new episodes of that series. “RecordNow” with arguments (streamId, duration) may record a given stream for a specified duration starting immediately. If no duration may be specified a current program may be determined and a remaining duration may be calculated.

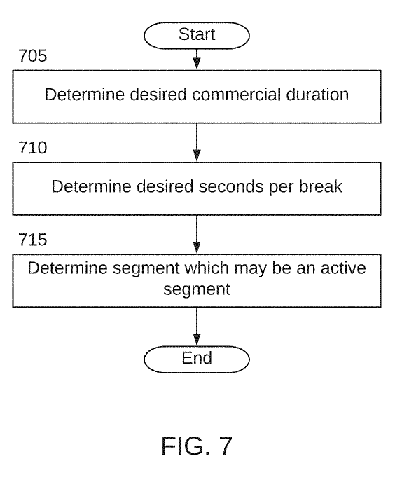

FIG. 7 is a flow chart illustrating an algorithm for creating linear streams from On-Demand or archived content, in accordance with an embodiment of the invention. “Live” linear television may often-times be just archived programming delivered at a specific timeslot. With access to an on-demand library of content, it may be easy to create several linear curated TV streams. To mimic traditional broadcast television, it is often desired to make the programming end on the half-hour or hour so that the channel or stream is easily navigable in a program grid view. Therefore an algorithm is shown to be able to create such a channel or stream and utilize “filler” material to cause the programs to fill such even timeslots. The following algorithm describes how to create such a stream given a LiveEpisode model including but not limited to following attributes: a URL of root media, a list of cuePoints which may be timestamps in a media where ads may be inserted, a time at which a media may start broadcasting, an actual duration of media, a desired duration of media during a broadcast (this may usually be an actual duration rounded to a nearest hour of half-hour or whatever time is necessary to fill the allotted time for the program). In Step 705 an algorithm may determine a desired duration of the “filler” material by subtracting an actual duration of the main media content from a desired duration of the timeslot the media should fill. This “filler” material may include commercials or other promo or short form video other than the main media content. In a Step 710 an algorithm may determine desired seconds per break, by dividing a desired commercial duration by a number of cuePoints or applying some weighting to different cuePoints (i.e. a lot of times a system may want more commercials towards an end of an episode when users may be more engaged). Regardless of the method used to determine each break length, the sum of the break lengths plus the sum of the main media content's length should equal the desired timeslot's length. In a Step 715 an algorithm at a given time that a live manifest may be requested, may determine a segment which may be an active segment (i.e. head of a live window). A sum of all segments prior to this segment may equal a current position of a program, including ads. For example, if a program was set to begin at 12:00 pm (as defined by a time at which media will start broadcasting) and a time may currently be 12:30 pm, then a total sum of all segments prior to a segment at a head of a manifest should be 30 minutes. A segment list may be iterated backwards and a manifest may be populated with segment URLs until a total duration of segments in a manifest may be equal to or greater than a live window constant. A manifest may be returned as a HTTP response. As long as a #EXT-X-ENDLIST may not added to an end of a manifest a stream may be considered “live” and clients may be refreshed a manifest periodically.

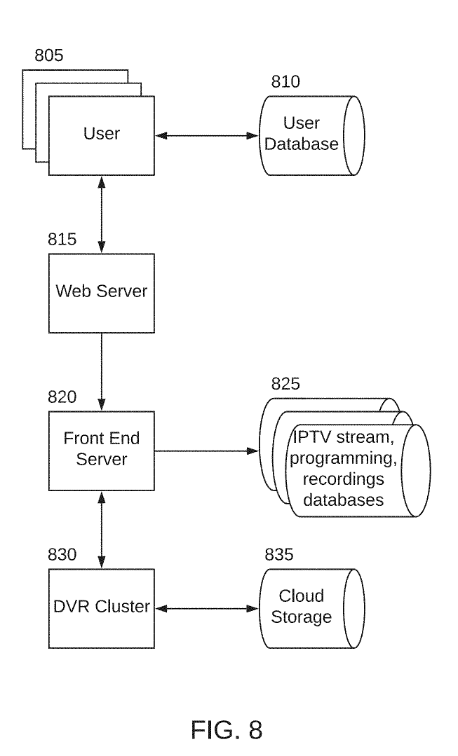

FIG. 8 illustrates an exemplary software system modules architecture for a cloud DVR, in accordance with an embodiment of the invention. In this system a user 805 may have a database 810 containing user specific data. The user 805 may connect to a front end server 820 through a web server 815 where API requests may be sent through. The front end server 820 may have databases for IPTV streams, programming, and recordings 825. The front end server 820 may connect to a DVR cluster 830 through a message bus. The DVR cluster may have a cloud storage database 835.

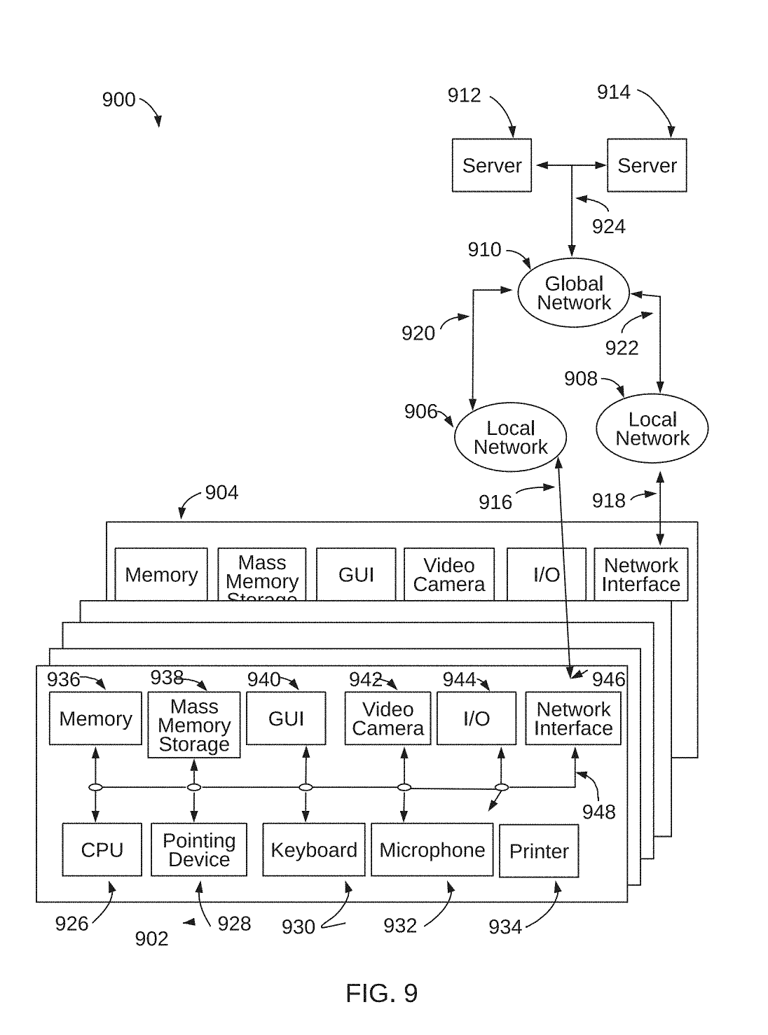

FIG. 9 is a block diagram depicting an exemplary client/server system which may be used by an exemplary web-enabled/networked embodiment of the present invention.

A communication system 900 includes a multiplicity of clients with a sampling of clients denoted as a client 902 and a client 904, a multiplicity of local networks with a sampling of networks denoted as a local network 906 and a local network 908, a global network 910 and a multiplicity of servers with a sampling of servers denoted as a server 912 and a server 914.

Client 902 may communicate bi-directionally with local network 906 via a communication channel 916. Client 904 may communicate bi-directionally with local network 908 via a communication channel 918. Local network 906 may communicate bi-directionally with global network 910 via a communication channel 920. Local network 908 may communicate bi-directionally with global network 910 via a communication channel 922. Global network 910 may communicate bi-directionally with server 912 and server 914 via a communication channel 924. Server 912 and server 914 may communicate bi-directionally with each other via communication channel 924. Furthermore, clients 902, 904, local networks 906, 908, global network 910 and servers 912, 914 may each communicate bi-directionally with each other.

In one embodiment, global network 910 may operate as the Internet. It will be understood by those skilled in the art that communication system 900 may take many different forms. Non-limiting examples of forms for communication system 900 include local area networks (LANs), wide area networks (WANs), wired telephone networks, wireless networks, or any other network supporting data communication between respective entities.

Clients 902 and 904 may take many different forms. Non-limiting examples of clients 902 and 904 include personal computers, personal digital assistants (PDAs), cellular phones and smartphones.

Client 902 includes a CPU 926, a pointing device 928, a keyboard 930, a microphone 932, a printer 934, a memory 936, a mass memory storage 938, a GUI 940, a video camera 942, an input/output interface 944 and a network interface 946.

CPU 926, pointing device 928, keyboard 930, microphone 932, printer 934, memory 936, mass memory storage 938, GUI 940, video camera 942, input/output interface 944 and network interface 946 may communicate in a unidirectional manner or a bi-directional manner with each other via a communication channel 948. Communication channel 948 may be configured as a single communication channel or a multiplicity of communication channels.

CPU 926 may be comprised of a single processor or multiple processors. CPU 926 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 936 is used typically to transfer data and instructions to CPU 926 in a bi-directional manner. Memory 936, as discussed previously, may include any suitable computer-readable media, intended for data storage, such as those described above excluding any wired or wireless transmissions unless specifically noted. Mass memory storage 938 may also be coupled bi-directionally to CPU 926 and provides additional data storage capacity and may include any of the computer-readable media described above. Mass memory storage 938 may be used to store programs, data and the like and is typically a secondary storage medium such as a hard disk. It will be appreciated that the information retained within mass memory storage 938, may, in appropriate cases, be incorporated in standard fashion as part of memory 936 as virtual memory.

CPU 926 may be coupled to GUI 940. GUI 940 enables a user to view the operation of computer operating system and software. CPU 926 may be coupled to pointing device 928. Non-limiting examples of pointing device 928 include computer mouse, trackball and touchpad. Pointing device 928 enables a user with the capability to maneuver a computer cursor about the viewing area of GUI 940 and select areas or features in the viewing area of GUI 940. CPU 926 may be coupled to keyboard 930. Keyboard 930 enables a user with the capability to input alphanumeric textual information to CPU 926. CPU 926 may be coupled to microphone 932. Microphone 932 enables audio produced by a user to be recorded, processed and communicated by CPU 926. CPU 926 may be connected to printer 934. Printer 934 enables a user with the capability to print information to a sheet of paper. CPU 926 may be connected to video camera 942. Video camera 942 enables video produced or captured by user to be recorded, processed and communicated by CPU 926.

CPU 926 may also be coupled to input/output interface 944 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 926 optionally may be coupled to network interface 946 which enables communication with an external device such as a database or a computer or telecommunications or internet network using an external connection shown generally as communication channel 916, which may be implemented as a hardwired or wireless communications link using suitable conventional technologies. With such a connection, CPU 926 might receive information from the network, or might output information to a network in the course of performing the method steps described in the teachings of the present invention.

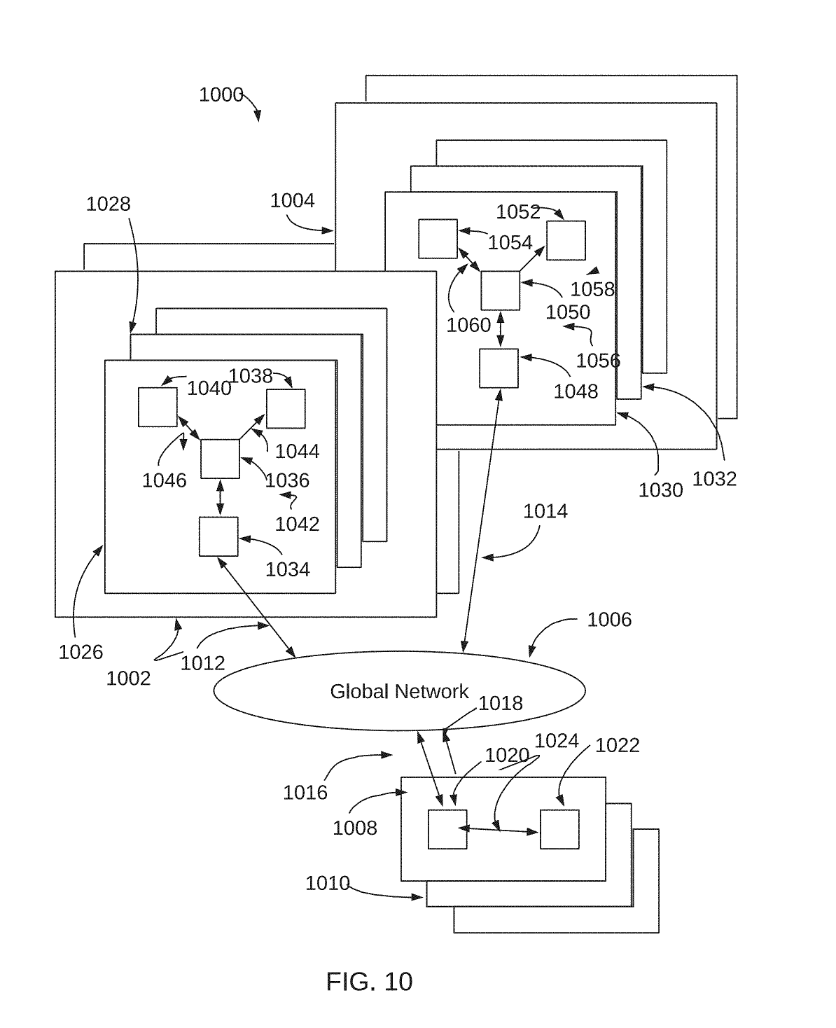

FIG. 10 illustrates a block diagram depicting a conventional client/server communication system, which may be used by an exemplary web-enabled/networked embodiment of the present invention.

A communication system 1000 includes a multiplicity of networked regions with a sampling of regions denoted as a network region 1002 and a network region 1004, a global network 1006 and a multiplicity of servers with a sampling of servers denoted as a server device 1008 and a server device 1010.

Network region 1002 and network region 1004 may operate to represent a network contained within a geographical area or region. Non-limiting examples of representations for the geographical areas for the networked regions may include postal zip codes, telephone area codes, states, counties, cities and countries. Elements within network region 1002 and 1004 may operate to communicate with external elements within other networked regions or within elements contained within the same network region.

In some implementations, global network 1006 may operate as the Internet. It will be understood by those skilled in the art that communication system 1000 may take many different forms. Non-limiting examples of forms for communication system 1000 include local area networks (LANs), wide area networks (WANs), wired telephone networks, cellular telephone networks or any other network supporting data communication between respective entities via hardwired or wireless communication networks. Global network 1006 may operate to transfer information between the various networked elements.

Server device 1008 and server device 1010 may operate to execute software instructions, store information, support database operations and communicate with other networked elements. Non-limiting examples of software and scripting languages which may be executed on server device 1008 and server device 1010 include C, C++, C# and Java.

Network region 1002 may operate to communicate bi-directionally with global network 1006 via a communication channel 1012. Network region 1004 may operate to communicate bi-directionally with global network 1006 via a communication channel 1014. Server device 1008 may operate to communicate bi-directionally with global network 1006 via a communication channel 1016. Server device 1010 may operate to communicate bi-directionally with global network 1006 via a communication channel 1018. Network region 1002 and 1004, global network 1006 and server devices 1008 and 1010 may operate to communicate with each other and with every other networked device located within communication system 1000.

Server device 1008 includes a networking device 1020 and a server 1022. Networking device 1020 may operate to communicate bi-directionally with global network 1006 via communication channel 1016 and with server 1022 via a communication channel 1024. Server 1022 may operate to execute software instructions and store information.

Network region 1002 includes a multiplicity of clients with a sampling denoted as a client 1026 and a client 1028. Client 1026 includes a networking device 1034, a processor 1036, a GUI 1038 and an interface device 1040. Non-limiting examples of devices for GUI 1038 include monitors, televisions, cellular telephones, smartphones and PDAs (Personal Digital Assistants). Non-limiting examples of interface device 1040 include pointing device, mouse, trackball, scanner and printer. Networking device 1034 may communicate bi-directionally with global network 1006 via communication channel 1012 and with processor 1036 via a communication channel 1042. GUI 1038 may receive information from processor 1036 via a communication channel 1044 for presentation to a user for viewing. Interface device 1040 may operate to send control information to processor 1036 and to receive information from processor 1036 via a communication channel 1046. Network region 1004 includes a multiplicity of clients with a sampling denoted as a client 1030 and a client 1032. Client 1030 includes a networking device 1048, a processor 1050, a GUI 1052 and an interface device 1054. Non-limiting examples of devices for GUI 1038 include monitors, televisions, cellular telephones, smartphones and PDAs (Personal Digital Assistants). Non-limiting examples of interface device 1040 include pointing devices, mousse, trackballs, scanners and printers. Networking device 1048 may communicate bi-directionally with global network 1006 via communication channel 1014 and with processor 1050 via a communication channel 1056. GUI 1052 may receive information from processor 1050 via a communication channel 1058 for presentation to a user for viewing. Interface device 1054 may operate to send control information to processor 1050 and to receive information from processor 1050 via a communication channel 1060.

For example, consider the case where a user interfacing with client 1026 may want to execute a networked application. A user may enter the IP (Internet Protocol) address for the networked application using interface device 1040. The IP address information may be communicated to processor 1036 via communication channel 1046. Processor 1036 may then communicate the IP address information to networking device 1034 via communication channel 1042. Networking device 1034 may then communicate the IP address information to global network 1006 via communication channel 1012. Global network 1006 may then communicate the IP address information to networking device 1020 of server device 1008 via communication channel 1016. Networking device 1020 may then communicate the IP address information to server 1022 via communication channel 1024. Server 1022 may receive the IP address information and after processing the IP address information may communicate return information to networking device 1020 via communication channel 1024. Networking device 1020 may communicate the return information to global network 1006 via communication channel 1016. Global network 1006 may communicate the return information to networking device 1034 via communication channel 1012. Networking device 1034 may communicate the return information to processor 1036 via communication channel 1042. Processor 1076 may communicate the return information to GUI 1078 via communication channel 1044. User may then view the return information on GUI 1038.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6). In some embodiments, the methods and/or system components which may be located and/or performed remotely include, without limitation.

It is noted that according to USA law, all claims must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breath life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing television according to the present invention will be apparent to those skilled in the art. Various aspects of the invention have been described above by way of illustration, and the specific embodiments disclosed are not intended to limit the invention to the particular forms disclosed. The particular implementation of the television may vary depending upon the particular context or application. By way of example, and not limitation, the television described in the foregoing were principally directed to television recording implementations; however, similar techniques may instead be applied to audio recording, non-cable television video recording, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a database of at least one or more IPTV stream, in which said at least one or more IPTV stream comprises a predetermined URL where said at least one or more IPTV stream is accessed;
a frontend server that is configured to provide an API being operable for at least one of, providing a requested programming information to a requester or client device and accepting a recording request from said client device;
a database of a user-requested recording for each program, wherein said user-requested recording database is configured to be operable for browsing by a user of said client device;
a cloud DVR, said cloud DVR is configured to be operable for a fault-tolerant recording of said least one or more IPTV stream, wherein said cloud DVR is configured to form a cloud DVR cluster; and
a cloud DVR cluster monitor, said cloud DVR cluster monitor is configured to be operable for ensuring that enough recording capacity exists in said cloud DVR cluster, wherein said cloud DVR monitor is further configured to be operable for detecting if said recording capacity had been limited.

2. The system of claim 1, further comprising an authentication module, wherein said authentication module is configured to grant a client device access to a requested stream, and wherein said authentication module is configured to be operable for passing authentication information to said client device, in which said authentication information comprises an authentication token attached to said predetermined URL or in a cookie value.

3. The system of claim 2, further comprising a programming database or service that is configured to provide Program Guide data of what programs air on said one or more IPTV stream and at what times, in which said one or more IPTV stream comprises at least a live stream.

4. The system of claim 3, in which said DVR cluster comprises at least one or more DVR nodes, wherein said cloud DVR monitor is further configured to be operable for detecting if a DVR node has become unresponsive.

5. The system of claim 4, further comprising a message bus connecting component.

6. The system of claim 5, further comprising an internet accessible storage medium or Content Delivery Network (CDN).

7. The system of claim 6, further comprising a post-processing module or node.

8. The system of claim 7, further comprising a scheduler.

9. The system of claim 1, in which said IPTV stream comprises at least one of, a HLS (HTTP Live Stream), a MPEG-DASH, a SmoothStream, an Adobe HDS, a RTMP, a RTSP/RTP, and a WebRTC.

10. The system of claim 9, in which said one or more IPTV stream further comprises at least one of, a linear stream and an on-demand stream.

11. The system of claim 10, in which said linear stream has no ending, and wherein said linear stream is configured to be operable for streaming at a certain time of a certain day of a week.

12. The system of claim 11, in which said on-demand stream has a singular program on said stream, wherein said on-demand stream is configured to end when said singular program is finished.

13. The system of claim 12, in which said client device comprises at least one of, a TV, a mobile device, a desktop, a web browser, and a voice-based assistant.

14. The system of claim 13, wherein said voice-based assistant is configured to interact with said front-end server via API calls.

15. The system of claim 14, further comprising a list of recorded voice option, said list of recorded voice option comprises one or more recorded voice option, wherein said list of recorded voice option is configured with said voice-based assistant, and wherein said list of recorded voice option is transmitted to said front-end server for storing to said recording database.

16. A method comprising the steps for:
requesting at least one stream from a front end server coupled to at least one of, a database storing streams, a programming database, a recordings database, and an IP or IPTV stream database;
receiving said at least one stream from said front end server stored in said IP or IPTV stream database;
browsing or searching, with a client device, said at least one stream for a program, in which said client device comprises at least one of, a TV, a mobile device, a desktop, a web browser, and a voice-based assistant;
selecting a program for recording to at least one of, a DVR node, said recording database, and said programming database;
sending a request, to said front end server, to record said selected program; and
receiving a message that a recording process has commenced for said selected program.

17. The method of claim 16, further comprising the steps for recording a list of voice command options with said voice-based assistant and transmitting said list of voice command options to said front-end server for storage to said recording database.

18. The method of claim 17, in which said message receiving step further comprising the steps for receiving a message from said DVR node stating recording is complete, wherein said recording is configured to be served from said cloud storage medium, and wherein if an error occurs during said recording process, said recording process is marked as failed and an alternative recording process is scheduled for a later time, alternative channel or on-demand stream.

19. The method of claim 18, further comprising the steps for monitoring a progress of a recording process with said client device, wherein a DVR node may be determined to be reaching capacity based on a predetermined limit.

20. A system comprising:
means for storing at least one or more stream, in which said at least one or more stream comprises a predetermined URL where said at least one or more stream is accessed;
means for accepting a recording request from a requester or client device, said accepting means includes a means for providing a requested programming information to said requester or client device;
means for storing a user-requested recording for each program, wherein said user-requested recording database is configured to be operable for browsing by a user of said client device;
means for recording of said least one or more stream, wherein said recording means comprises a fault-tolerant recording means, in which said recording means is configured to form a cloud fault-tolerant recording cluster;
means for detecting if a recording capacity has been reached; and
means for recording a voice command, in which said voice command recording means comprise a means for transmitting said voice command to said recording request accepting means for storage to said recording storing means.
